(19) United States
(12) Patent Application Publication
(10) Pub. No.: US 2008/0073094 A1
(43) Pub. Date: Mar. 27, 2008

(54) Shaft for power impact tool

(75) Inventor: Chin-Yi Lu, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/594,212

(22) Filed: Nov. 8, 2006

(30) Foreign Application Priority Data
Aug. 24, 2006 (TW) 95215037

(51) Int. Cl. B25D 11/00

(52) U.S. Cl. 173/104

(57) ABSTRACT

A shaft for a power impact tool includes a shaft base and a shaft body perpendicularly extending from the center of a first end face of the shaft base. The shaft body has two actuating slots symmetrically formed on the periphery thereof at two sides and provided with a middle part and two distal ends disposed relatively closer to the shaft base than the middle part. The shaft base has a second end face on which at least two recesses are symmetrically formed, and a hole coaxially extending from the center of the second end face toward the inside of the shaft body with a predetermined distance in such a manner that the center axis of the hole is same as the center axis of the shaft body to effectively diminish possible vibration during rotation of the shaft.

### BACKGROUND OF THE INVENTION

1. Field of the Invention

The present invention relates to power impact tools, such as pneumatic impact wrenches and electrical impact screwdrivers, and more specifically, to a shaft for the power impact tool.

2. Description of the Related Art

A power impact tool that outputs a rotary driving force, such as a pneumatic impact wrench, an electrical impact screwdriver, and etc., will output a continuous impact force rapidly corresponding to the direction of rotation when the output rotary driving force encounters a resistance, thereby facilitating performance of rotating the workpiece.

As shown in FIGS. 1 and 2, an impact generating mechanism A of a conventional electrical tool comprises a shaft A1, a spring A2, an impact member A3, two actuating steel balls A4, and an output member A5. The shaft A1 is used to rotate the impact member A3 which is in turn to rotate the output member A5. As soon as the output member A5 is stopped from rotation upon receiving an exceeding resistance, the shaft A1 will drive the impact member A3 to impart an impact force to the output member A5 for trying to further drive the output member to rotate.

According to the current practice, the shaft A1 is made by a solid metal bar member, as shown in FIG. 2, so that it is generally heavy. This heavy shaft A1 is a heavy load to the motor of the electrical tool. If the shaft A1 is biased from the center of rotation, or if an offset is generated between the center of gravity of the shaft A1 and the center of rotation, the heavy weight of the shaft A1 enhances vibration of the shaft A1 during its rotary motion, thereby shortening the working life of the transmission system of the electrical tool.

### SUMMARY OF THE INVENTION

The present invention has been accomplished under the circumstances in view. It is one objective of the present invention to provide a shaft for a power impact tool, which has a light weight and does not easily cause vibration during rotation.

To achieve this objective of the present invention, the shaft for a power impact tool comprises a shaft base, a shaft body coaxially extending from the shaft base, a plurality of recesses symmetrically formed on the shaft base and a hole coaxially extending from the shaft base towards an inside of the shaft body with a predetermined depth, thereby lightening the weight of the shaft so as to diminishing the possible vibration of the shaft during rotation.

In a preferred embodiment of the present invention, the shaft base is provided with two smoothly arched recesses symmetrically and equiangularly formed on an end face thereof. In addition, the hole is a counterboring hole having a first section defining an opening on the end face of the shaft base and corresponding substantially in location to the shaft base, and a second section having a diameter smaller than that of the first section and corresponding substantially in location to the shaft body. In another preferred embodiment of the present invention, the shaft base is provided with a plurality of circular recesses symmetrically and equiangularly formed on the end face thereof and the counterboring hole has a polygonal cross section.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded view of an impact generating mechanism for a conventional electrical impact tool according to the prior art;

FIG. 2 is a cross-sectional view of the impact generating mechanism shown in FIG. 1;

FIG. 3 is a perspective view of a shaft for a power impact tool according to a first preferred embodiment of the present invention;

FIG. 4 is a side view of the shaft shown in FIG. 3;

FIG. 5 is a rear side view of the shaft shown in FIG. 3;

FIG. 6 is a cross-sectional view taken along line 6-6 of FIG. 5, and

FIG. 7 is a rear side view of a shaft for a power impact tool according to a second preferred embodiment of the present invention.

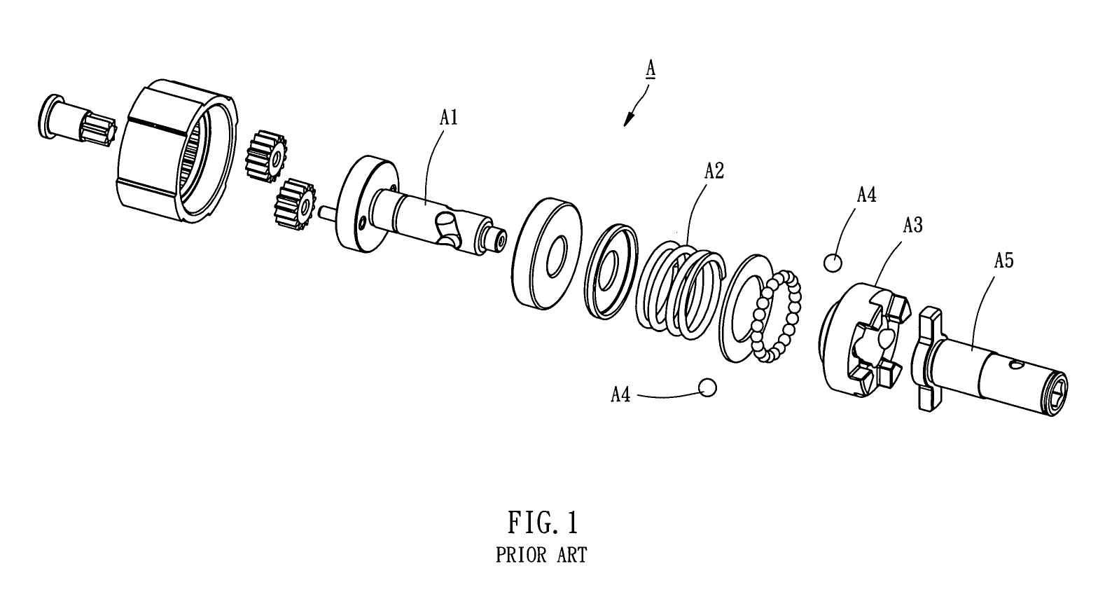

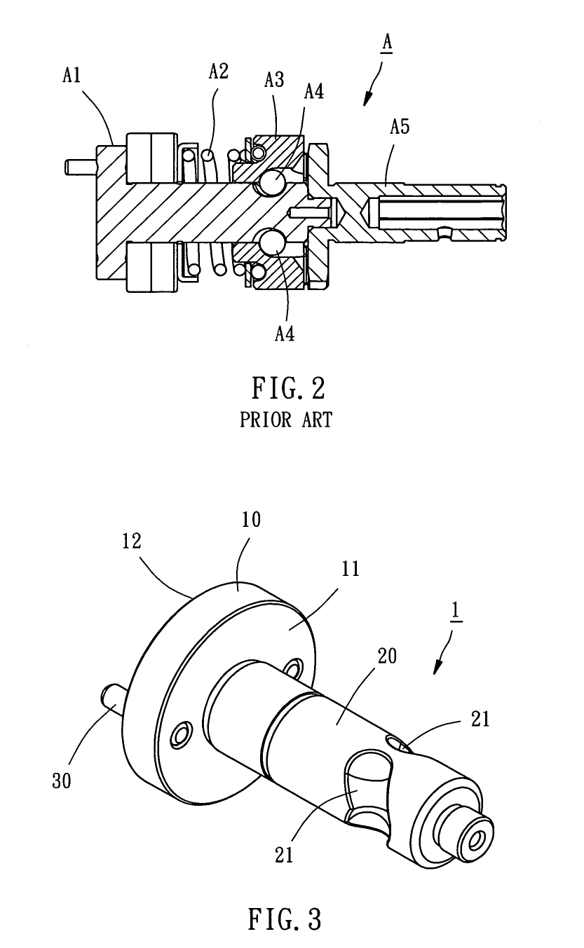

### DETAILED DESCRIPTION OF THE INVENTION

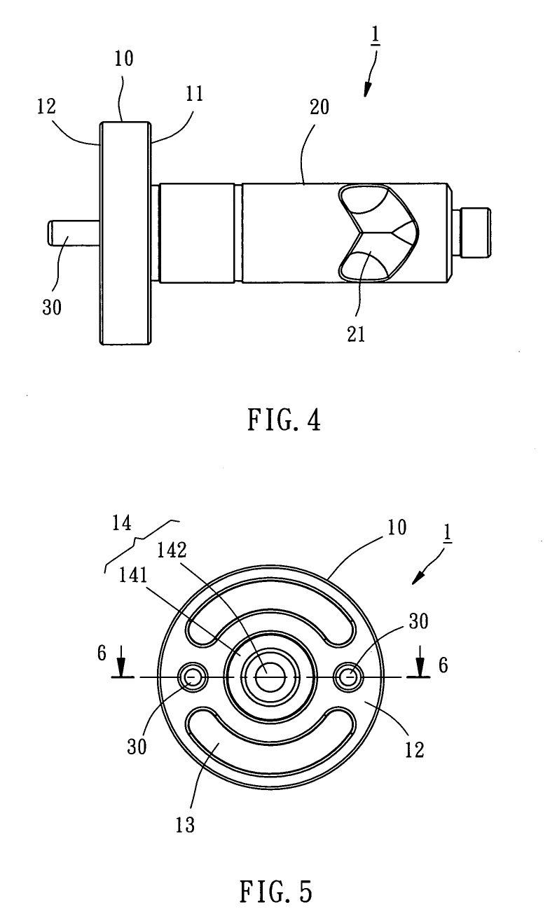

As shown in FIGS. 3-6, a shaft 1 for use in a power impact tool, such as an electrical impact screwdriver, an electrical impact wrench, and etc., in accordance with a first preferred embodiment of the present invention comprises a shaft base 10, a shaft body 20 and two gear carriers 30.

The shaft base 10 has a short cylinder-like shape, having a first end face 11 and a second end face 12 opposite to the first end face 11.

The shaft body 20 is shaped like a round rod and coaxially connected with its one end to the first end face 11 of the shaft base 10. The shaft body 20 has two actuating slots 21 of same shape symmetrically equiangularly formed on the periphery at two sides of the shaft body 20. Each actuating slot 21 has two distal ends disposed relatively closer to the shaft base 10 than the middle part of the actuating slot 21.

The two gear carriers 30, which are respectively embodied as a rod member in this embodiment, symmetrically and perpendicularly extend from the second end face 12 of the shaft base 10 for pivotally mounting with a respective gear.

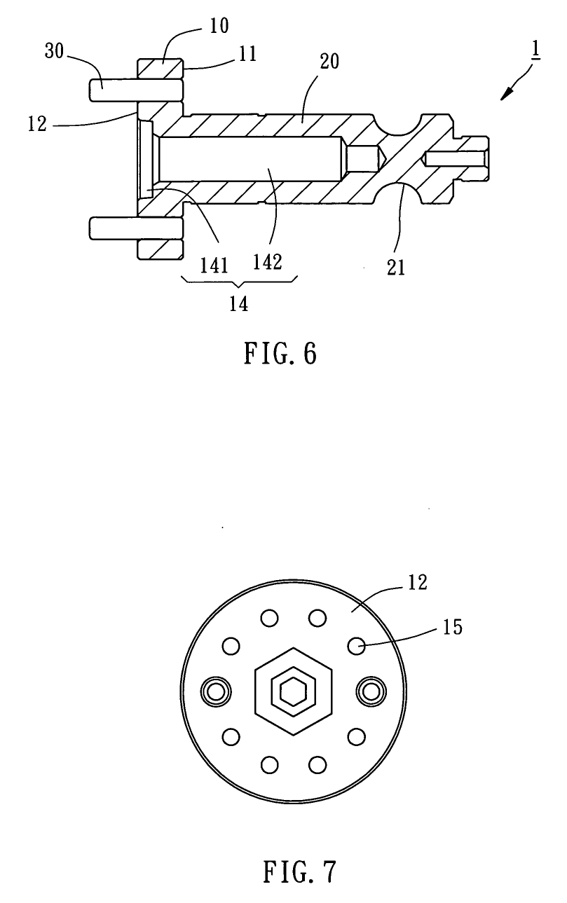

As shown in FIGS. 5 and 6, the shaft base 10 has two smoothly arched recesses 13 symmetrically formed on the second end face 12 corresponding to the curvature of the periphery of the shaft base 10. Further, a counterboring hole 14 extends coaxially through the center of the second end face 12 to the inside of the shaft body 20, that is, the center axis of the counterboring hole 14 is same as the center axis of the shaft body 20. The counterboring hole 14 has a first section 141, namely the bottom portion, and a second section 142, namely the body portion. The first section 141 forms an opening on the second end face 12 of the shaft base 10. The second section 142 is coaxially extending from one end of the first section 141 opposite to the second end face 12, having an inner diameter smaller than the first section 141.

The formation of the arched recesses 13 and the counterboring hole 14 greatly reduces the weight of the shaft 1, preventing vibration of the shaft 1 due to potential offset between the center of gravity of the shaft 1 and the center of rotation during rotation of the shaft 1. Further, the arrangement of the two symmetrical arched recesses 13 and the counterboring hole 14 having the first section 141 corresponding in location to the shaft base 10 and the second section 142 corresponding in location to the shaft body 20 can effectively diminish the possible potential offset between the center of gravity of the shaft 1 and the center of rotation, thereby effectively lessening vibration during rotation of the shaft 1.

In the aforesaid embodiment as shown in FIGS. 3-6, the shaft base 10 has two smoothly arched recesses 13 symmetrically formed on the second end face 12. FIG. 7 shows an alternate form of the present invention. According to this embodiment, a plurality of circular recesses 15 are formed on the second end face 12 and equiangularly spaced along the border. This embodiment achieves the same effect. Further, in the aforesaid first embodiment as shown in FIG. 5, the counterboring hole 14 has a circular cross section. Alternatively, the counterboring hole 14 can be made having a square or hexagonal cross section, or any of other regular polygonal cross sections.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A shaft for a power impact tool, the shaft comprising:
a shaft base having substantially a short cylinder shape, a first end face and a second end face opposite to the first end face;
a shaft body having substantially a round rod shape with a diameter smaller than a diameter of the shaft base, the shaft body having an end coaxially connected to the first end face of the shaft base, and two actuating slots with same shape symmetrically formed on a periphery of the shaft body, wherein the actuating slots each have a middle part and two distal ends disposed relatively closer to the shaft base than the middle part;
wherein the shaft base has at least two recesses symmetrically formed on the second end face without communication with each other, and a hole coaxially extending from a center of the second end face toward an inside of the shaft body with a predetermined distance, an imaginary center axis of said hole and an imaginary axis of said shaft overlapping each other, said hole having a first section and a second section communication with said first section, said first section having an opening on said second end face of said shaft base, and said second section being coaxially extending from one end of said first section opposite to said second end face and having an inner diameter smaller than said first section.

2. The shaft as claimed in claim 1, further comprising two gear carriers symmetrically and perpendicularly extending from the second end face of the shaft base for pivotally mounting with two gears respectively.

3. The shaft as claimed in claim 1, wherein the shaft base comprises two said recesses which are smoothly arched.

4. The shaft as claimed in claim 1, wherein the shaft base comprises a plurality of said recesses which are circular recesses equiangularly spaced along a border of the second end face of the shaft base.

5. (canceled)

6. The shaft as claimed in claim 1, wherein the hole has a square cross section.

7. The shaft as claimed in claim 1, wherein the hole has a hexagonal cross section.
